(19) United States
(12) Patent Application Publication
(10) Pub. No.: US 2026/0088926 A1
(43) Pub. Date: Mar. 26, 2026

(54) METHOD FOR CORRECTING ERRORS OCCURING IN A MULTICAST SESSION AND SYSTEM THEREOF

(71) Applicant: ARRIS ENTERPRISES LLC, Horsham, PA (US)

(72) Inventors: Kanakendiran RAMACHANDIRAN, Bengaluru (IN); Varma L. CHANDERRAJU, San Jose, CA (US)

(73) Assignee: ARRIS ENTERPRISES LLC, Horsham, PA (US)

(21) Appl. No.: 19/105,779

(22) PCT Filed: Aug. 17, 2023
(86) PCT No.: PCT/US2023/030489

§ 371 Date: Feb. 21, 2025

(30) Foreign Application Priority Data
Aug. 23, 2022 (IN) 202241048030

(51) Int. Cl. H04L 1/00; H04L 5/00

(52) U.S. Cl. CPC H04L 1/0009; H04L 1/0019; H04L 1/0061; H04L 5/0053; H04L 2001/0093

(57) ABSTRACT

The present disclosure recites techniques for correcting errors occurring in a multicast session. Precisely, the disclosure recites periodically receiving, data packets, comprising metrics including the existence of packet error, corresponding to a single multicast session, from plurality of client devices placed across one or more zones. The disclosure further recites selectively disabling a Not-Acknowledge (NACK) setting for each of the plurality of client devices using the metrics. Additionally, the method recites selectively enabling a Forward Error Correction's (FEC) setting for each of the plurality of client devices using the metrics.

### CROSS-REFERENCE TO RELATED APPLICATIONS

The present application claims priority to provisional Indian Patent Application No. 202241048030, filed Aug. 23, 2022, the content of which is incorporated herein by reference in its entirety.

### TECHNICAL FIELD

The present disclosure generally relates to Multicast Adaptive Bit Rate (MABR) systems and more particularly, but not exclusively, to techniques for correcting errors that occur in multicast sessions when streaming content through a Multicast Adaptive Bit Rate (MABR) system.

### BACKGROUND

Multicast Adaptive Bit Rate (MABR) systems use multicast servers to efficiently deliver the same content to multiple client devices in a geographical area. To ensure efficient and reliable content delivery to the multiple client devices, these multicast servers use various protocols such as RTP Extensions, NORM, ROUTE, FLUTE etc. Specifically, these protocols make use of one or more error correcting mechanisms while delivering the content to the client devices. Two of the most common error correcting mechanisms used by these protocols are Forward Error Correction (FEC) and NACK enablement. The FEC mechanism uses coding for error detection and correction. In particular, using FEC, the multicast servers encode the content with redundant information in the form of Error Correcting Codes (ECC). This redundancy allows the client devices to detect a limited number of errors that may occur anywhere in the content, and to correct these errors without retransmission. The NACK enablement mechanism allows the client device to send a NACK (Negative ACKnowledgement) for missing packets to the multicast servers and the multicast servers may then re-transmit the missing packets indicated in the NACK message.

However, in existing MABR systems, the ECC capability of the FEC mechanism for the multicast server and the decision of enabling NACKs in the client devices is determined before the start of multicast session and is normally configured to be the same for all the multicast servers. Thus, these error correcting mechanisms work on parameters that are static in nature and do not address the changing dynamics of the network conditions in the real-world. Further, all client devices sending NACKs at around the same time could trigger a problem of NACK implosion.

Thus, there exists a need of a technology for error correcting mechanisms, for efficient content delivery in MABR systems, which can adapt with the changing dynamics of the network in the real-world.

The information disclosed in this background section is only for enhancement of understanding of the general background of the invention and should not be taken as an acknowledgement or any form of suggestion that this information forms the prior art already known to a person skilled in the art.

### SUMMARY

According to an aspect of the present disclosure, a method, a system and a computer readable medium for efficiently correcting errors that occur in multicast sessions when streaming content using a Multicast Adaptive Bit Rate (MABR) system are disclosed.

In a non-limiting embodiment of the present disclosure, a Multicast Adaptive Bitrate (MABR) system for correcting errors occurring in a multicast session is disclosed. The system comprises a processor that is configured to periodically receive, data packets from each of plurality of client devices. The data packets received from each of the plurality of client devices including metrics indicating the existence of packet error. The processor may then preferably be configured to selectively disable a Not-Acknowledge (NACK) setting for each of the plurality of client devices using a first set of the metrics. Additionally, the processor may be configured to dynamically adjust a Forward Error Correction (FEC) setting for each of the plurality of client devices using a second set of the metrics different than the first set of the metrics, where dynamic adjustment of the FEC setting changes the first set of metrics in a manner that affects the selective disabling of the NACK setting for each of the plurality of client devices.

In another non-limiting embodiment of the present disclosure, the processor uses the first set of the metrics, received from each of the plurality of client devices, to calculate an error percentage value (Percₑᵣᵣₒᵣ) used to selectively disable the NACK setting for each of the plurality of client devices.

In another non-limiting embodiment of the present disclosure, the processor is configured to selectively enable the NACK setting for each of the plurality of client devices based on the first set of the metrics.

In another non-limiting embodiment of the present disclosure, to dynamically adjust the FEC error setting for each of the plurality of client devices, the processor is configured to calculate a target error recovery rate for each of the plurality of client devices, using the second set of the metrics.

In another non-limiting embodiment of the present disclosure, the target error recovery rate is represented by p/k, wherein “p” is number of parity symbols per coding block and “k” is the number of source symbols per coding block within a data packet of the multicast session.

In a further non-limiting embodiment of the present disclosure, a method for correcting errors occurring in a multicast session is disclosed. The method may comprise periodically receiving data packets from each of the plurality of client devices the data packets received from each of the plurality of client devices including metrics including the existence of packet error. The method further comprises selectively disabling a Not-Acknowledge (NACK) setting for each of the plurality of client devices using a first set of the metrics. Additionally, the method comprises dynamically adjusting a Forward Error Correction (FEC) setting for each of the plurality of client devices using a second set of the metrics different from the first set of the metrics, where dynamic adjustment of the FEC setting changes the first set of metrics in a manner that affects the selective disabling of the NACK setting for each of the plurality of client devices

In a further non-limiting embodiment of the present disclosure, a processing device for delivering an adaptive bitrate multicast to a plurality of client devices grouped in a zone id disclosed. The multicast comprising a plurality of packets and the processing device receiving messages from each of the plurality of client devices quantifying a number of packet errors received in the multicast. The processing device being configured to dynamically adjust a number of FEC parity bits sent in the multicast based on the quantified number of packet errors

The foregoing summary is illustrative only and is not intended to be in any way limiting. In addition to the illustrative embodiments, and features described above, further embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. Some embodiments of system and/or methods in accordance with embodiments of the present subject matter are now described, by way of example only, and with reference to the accompanying Figures, in which:

FIG. 1 shows a basic architecture 100 illustration of a Multicast Adaptive Bit Rate (MABR) system showing plurality of multicast servers interacting with plurality of client devices placed in one or more zones, using error correction techniques disclosed in the present disclosure, for efficient content delivery.

FIG. 2 shows a detailed block diagram 200 of an error correction unit disclosed in FIG. 1.

FIG. 3 depicts a method 300 for correction of errors occurring in a multicast session for efficient content delivery in a Multicast Adaptive Bit rate (MABR) system.

FIG. 4 shows a method 310 for dynamic adjustment of FEC correction of errors occurring in a multicast session for efficient content delivery in a Multicast Adaptive Bit rate (MABR) system.

It should be appreciated by those skilled in the art that any block diagrams herein represent conceptual views of the illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the particular form disclosed, but on the contrary, the disclosure is to cover all modifications, equivalents, and alternatives falling within the spirit and the scope of the disclosure.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus proceeded by “comprises . . . a” does not, without more constraints, preclude the existence of other elements or additional elements in the system.

The terms like “at least one” and “one or more” may be used interchangeably or in combination throughout the description.

In the following detailed description of the embodiments of the disclosure, reference is made to the accompanying drawings that form a part hereof, and which are shown by way of illustration of specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. In the following description, well known functions or constructions are not described in detail since they would obscure the description with unnecessary detail.

The present disclosure describes methods, systems, and computer readable media for correcting errors that arise in a multicast session while streaming content to client devices using a Multicast Adaptive Bit Rate (MABR) system. The MABR system uses various delivery protocols such as FLUTE, NORM, ROUTE etc., to deliver multimedia content to the client devices reliably and efficiently. These protocols use one or more error correcting mechanisms such as Forward Error Correction (FEC) and NACK enablement. These error correcting mechanisms help the client devices to recover the data packets lost due to various errors, while multicasting.

In particular, the FEC mechanism makes use of coding for error detection and correction. For example, in the FEC, the multicast servers encode the content with redundant information in the form of Error Correcting Codes (ECC). The redundancy allows the client devices to detect a limited number of errors that may occur anywhere in the content, and to often correct these errors without retransmission. On the other hand, the NACK enablement mechanism allows the client devices to send a NACK (Negative ACKnowledgement) for missing packets to their respective multicast servers and the multicast servers may then re-transmit only the missing packets indicated in the NACK message to the client device.

In existing MABR systems, the ECC capability for the multicast server and the decision of enabling NACKs in the client devices are both determined before the start of multicast session. Further, error correcting parameters in both these mechanisms are normally configured to be the same for all the multicast servers. Thus, these error correcting mechanisms work on parameters that are static in nature and do not address the changing dynamics of the network in the real-world. Further, all the client devices sending NACKs at around the same time could trigger a problem of NACK implosion.

In an embodiment, the present disclosure addresses the above problems by using an algorithm that constantly monitors the health of the network from the data packets received from the plurality of client devices for each multicast session from each zone and performs calculations over the received data packets to perform a tradeoff between NACK enablement and FEC mechanism in case an error is encountered by one or more client devices. Further, the algorithm predicts the corrections required in the existing FEC settings based on the calculations, if FEC is to be used.

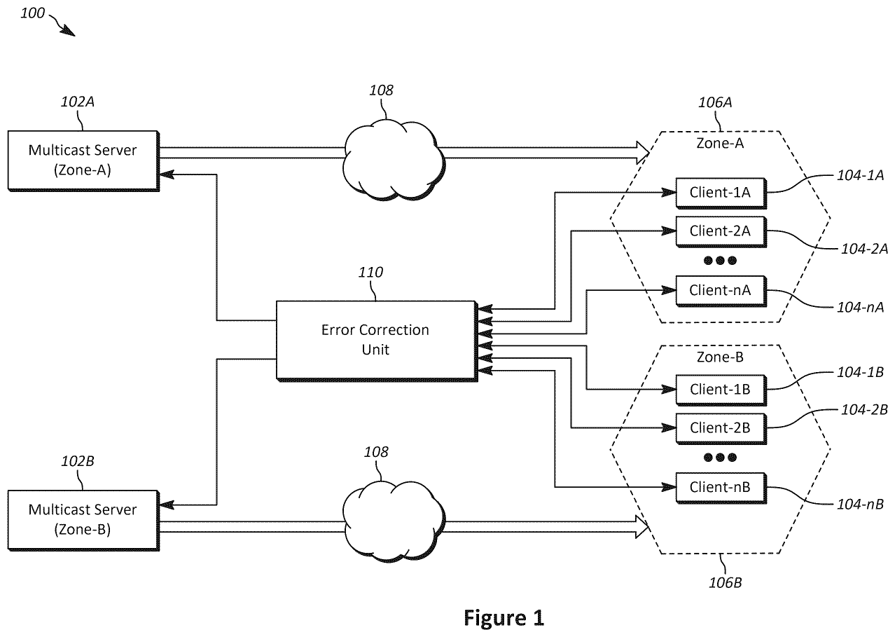

Referring now to FIG. 1, an exemplary basic architecture 100 illustration of a Multicast Adaptive Bit Rate (MABR) system showing plurality of multicast servers streaming multimedia content to plurality of client devices placed in respective zones, using error correction techniques of the present disclosure, for efficient content delivery is disclosed. The architecture 100 discloses a plurality of Multicast servers 102. In particular, architecture 100 discloses two multicast servers 102A and 102B streaming multimedia content to plurality of client devices 104 placed across one or more zones 106. In an exemplary embodiment, as shown in FIG. 1, the multicast server 102A is configured to stream multimedia content to the plurality of client devices 104-1A-104-nA placed in a first zone 106A, herein refereed as zone A, using a network 108. Similarly, the multicast server 102B is configured to stream multimedia content to the plurality of client devices 104-1B-104-nB placed in a second zone 106B, herein refereed as zone B, using the network 108. Those skilled in the art will appreciate that one multicast server 102 is configured to stream multimedia content to the plurality of client devices placed in a particular zone only. In the context of the present disclosure, the zone may be referred as a geographical area which can be served using a single multicast server 102.

In an aspect, FIG. 1 depicts a broad architectural overview of the MABR system where a plurality of multicast servers 102 are shown streaming content to the plurality of client devices 104 placed across distinct zones 106. Those skilled in the art will appreciate that FIG. 1 discloses an exemplary embodiment representing only two multimedia servers 102A and 102B streaming content to plurality of client devices 104 placed in two separate zones 106A and 106B, however the same shall not construed limiting in any senses and the number of multicast servers 102 and zones 106 served by these multicast servers 102 may vary. Furthermore, the architecture 100 only discloses system/unit/elements/components essential for explaining the present disclosure and there may be several other system/unit/elements/components that may form a part of the architecture 100 and are not required for explaining the invention and thus are not disclosed for the sake of clarity and conciseness. For example, although FIG. 1 shows a plurality of multicast servers, each serving a respective “zone” of client devices, those of ordinary skill in the art will appreciate that the embodiments disclosed in the present application may be used in systems with only one multicast server, and one “zone.” Alternatively, other embodiments may be used in architectures where a particular “zone” of client devices are capable of being served by multiple multicast servers e.g., for redundancy.

In an exemplary embodiment, the network 108 referred in the disclosure may comprise a data network such as, but not restricted to, the Internet, a Local Area Network (LAN), a Wide Area Network (WAN), a Metropolitan Area Network (MAN), etc. In certain embodiments, the network 108 may include a wireless network, such as, but not restricted to, a cellular network and may employ various technologies including Enhanced Data rates for Global Evolution (EDGE), General Packet Radio Service (GPRS), Global System for Mobile Communications (GSM), Internet protocol Multimedia Subsystem (IMS), Universal Mobile Telecommunications System (UMTS) etc. In one embodiment, the network 108 may include or otherwise cover networks or subnetworks, each of which may include, for example, a wired or wireless data pathway.

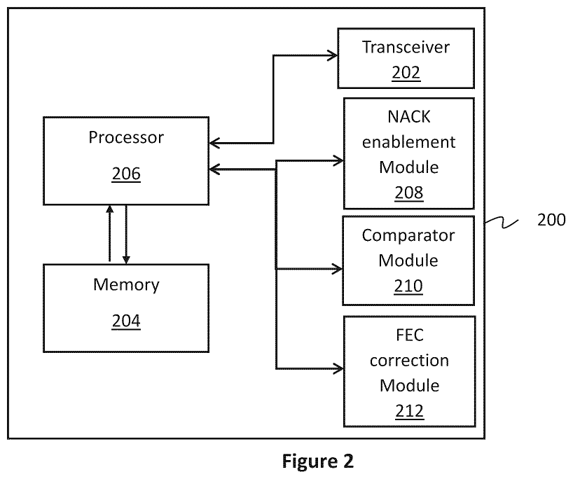

Referring again to FIG. 1, the architecture 100 further discloses an Error Correction Unit (ECU) 110 that may interact with each of the plurality of client devices 104 (1A-nA) and 104 (1B-nB), placed in the zones 106A and 106B respectively, and with the multicast servers 102A and 102B throughout the multicast session. In an aspect, the ECU 110 may be a separate unit placed at a suitable location within the MABR system. In another aspect, the ECU 110 may form an integral part of the multicast servers 102. However, for the sake of simplicity and for ease of understanding of the invention, the ECU 110 is taken as a distinct unit that is placed outside the multicast server 102. Further, the functioning of the ECU 110, for realization of the present disclosure, in explained in forth coming paragraphs, in conjunction with FIG. 1 and FIG. 2.

The ECU 110 may be configured to periodically receive data packets from each of the plurality of client devices 104 (1A-nA) and 104 (1B-nB) placed across the one or more zones 106A and 106B respectively. In an exemplary embodiment, the ECU 110 may be configured to periodically receive data packets from each of the plurality of client devices 104-1A-104-nA placed across the zone 106A and from each of the plurality of client devices 104-1B-104-nB placed across the zone 106B, through messages herein referred as heartbeat request messages. Referring to FIG. 2, the ECU 200 may include a transceiver 202 that is configured to periodically receive, data packets from one or more client devices 104 (1A-nA) and 104 (1B-nB) placed across one or more zones 106A and 106B. In an aspect, the data packets received from the plurality of client devices 104 (1A-nA) and 104 (1B-nB) placed in each zone 106A and 106B, respectively, correspond to a single multicast session, per zone. Further, these data packets include vital information regarding at least total number of packets received by that particular client device 104, number of packets with errors received by that particular client device 104 and number of packets repaired, in a multicast session. In a specific embodiment, the data packets received from each of the plurality of client devices 104 (1A-nA) and 104 (1B-nB) may include metrics indicating the existence of packet error.

These received data packets are compiled separately for each zone 106A and 106B by a memory 204 with the help of a processor 206, as shown in FIG. 2. After compilation of data packets, the processor 206 is configured to calculate an error percentage (Percₑᵣᵣₒᵣ) value from the received data packets for each zone 106A and 106B independently. In particular, to calculate the error percentage (Percₑᵣᵣₒᵣ) value the processor 206 uses equation (1) indicated below:

$$error percentage ( {Perc}_{error} ) value = ( {N}_{error} / {N}_{total} ) \times 100 , \qquad ( 1 )$$

wherein, Nₜₒₜₐₗ represents total number of client devices present in one zone, when calculating error percentage (Percₑᵣᵣₒᵣ) value for that particular zone and Nₑᵣᵣₒᵣ represents number of client devices that experience packet errors in the one zone.

Upon calculating the error percentage (Percₑᵣᵣₒᵣ) value, the processor 206 compares the calculated error percentage (Percₑᵣᵣₒᵣ) value with a pre-determined threshold NACK (Threshold_{Nack}) value that is stored in the memory 204. For comparison, the processor 206 may use a comparator module 210, as shown in FIG. 2. Further, as explained more thoroughly below, based on the comparison the processor 206 decides whether to enable/disable NACK service and/or whether to enable/disable/modify FEC service. In one embodiment, upon comparison, if the processor 206 determines that the calculated error percentage (Percₑᵣᵣₒᵣ) value in a zone, among plurality of zones 106A and 106B, is below a pre-determined threshold NACK (Threshold_{Nack}) value, the processor 206 selectively enables NACK for each of the plurality of client devices 104 in that particular zone. In an embodiment, the Threshold_{Nack}defines the error percentage threshold below which NACKs can be enabled. Those skilled in the art will appreciate that it is not advisable to enable NACK if too many client devices 104 are experiencing errors (i.e., packet loss) in the same zone, at the same time since this can result in NACK implosion. Thus, the Threshold_{Nack} is chosen such that enabling NACK services for client devices experiencing errors is not likely to result in NACK implosion.

Further, as shown in FIG. 2, to enable NACK service for each of the plurality of client devices 104 in the particular zone, among the plurality of zones 106A and 106B, the processor 206 may use a NACK enabling module 208. In an embodiment, the processor 206 decides whether to enable/disable NACK service for each of the plurality of client devices 104 based on the error percentage (Percₑᵣᵣₒᵣ) value calculated from the metrics received from the plurality of client devices 104, in that zone and instruct the NACK enabling module 208 to take an appropriate action. It is further to be appreciated that the processor 206 is configured to continuously calculate the error percentage (Percₑᵣᵣₒᵣ) value based on the data packets received in the form of the heartbeat messages from the client devices 104 throughout the streaming of the multimedia content, also referred herein as multicast session.

In some embodiments, if the processor 206 finds that the calculated error percentage (Percₑᵣᵣₒᵣ) value is greater than or equal to the pre-determined threshold NACK (Threshold_{Nack}) value, the processor 206 does not enable (or disables previously enabled) NACK services to avoid a potential NACK implosion. Thus, in such a scenario the processor 206 is configured to exclusively rely upon FEC error correction mechanisms. As explained below, in some embodiments error detection and correction may comprise either NACK enablement or forward error correction, but not both, and in such embodiments the ThresholdNack value is used to determine which mechanism is used. In alternate embodiments, however, both NACK enablement and FEC error correction may be used simultaneously, where the error percentage value (Percₑᵣᵣₒᵣ) may be used to modify the overhead used by FEC error correction i.e., to adjust the amount of redundant information added to a data stream. In such embodiments, when error percentage values—which measure the magnitude of errors uncorrected via the FEC mechanism—are low, little or perhaps even no redundant information may be added, but as the error percentage values rise redundant information may be gradually added, which has the effect of reducing, or at least inhibiting a rise in, the error percentage value and therefore inhibiting the disabling of the NACK setting for client devices in a zone. Conversely, when redundant information or parity bits are reduced, this has the tendency to of increasing the error percentage value towards the threshold at which the NACK setting is disabled. In other words, variations in the FEC settings (e.g., number of parity bits) modulates the operation of the NACK setting as being alternately enables or disabled. Similarly, in such embodiments, the NACK mechanism is essentially used to reduce as much as possible the overhead caused by FEC, but when the ThresholdNack value is reached the NACK mechanism is turned off and the FEC mechanism is exclusively relied upon. Preferably in such embodiments, the system/processor 206 is calibrated so that the maximum amount of redundant information is sent via the FEC mechanism when the error percentage value closely approaches, or equals, the ThresholdNack value.

Regardless of which embodiment is employed, when the FEC error correction mechanism is used, the processor 206 preferably selectively calculates a desired Forward Error Correction's (FEC) error recovery rate (ERR_{FEC}) for each of the plurality of client devices 104 placed in that zone, among the plurality of zones 106A and 106B based on the information retrieved from the received data packets. In an embodiment, ERR_{FEC} is represented by p/k, wherein “p” represents a chosen number of parity symbols per coding block and “k” represents number of source symbols per coding block within a data packet of the streamed multimedia session coded using FEC technique. In an embodiment, to calculate ERR_{FEC}, the processor 206 is configured to interact with FEC correction module 212, as shown in FIG. 2. The computation regarding ERR_{FEC} is preferably performed by the processor 206 in combination with the FEC correction Module 212 but in some embodiments may be performed by the processor alone, without the FEC correction Module 212.

In an exemplary embodiment, FEC technique may use one or more known coding methods for coding data packets of the streamed multimedia session. One such FEC technique discussed herein uses R S (Reed-Solomon) codes for coding data packets that can detect and correct up to p/2 symbols or can correct up to ‘p’ symbols (if error locations are known). Further, using RS as an erasure code one can correct missing packets/symbols which is the case in unreliable transports like UDP, where the n/w devices may drop packets. In an embodiment, using RS as an erasure code, up to ‘p’ packets/symbols can be corrected as the locations of missing packets/symbols are known. However, the FEC coding is not limited to the above discussed technique and various other known coding techniques may be used.

Further, in order to calculate the desired ERR_{FEC}, the processor 206 needs to calculate a value referred herein as Target Error Recovery Rate (ERR_{Target}) value for the Packet Error Rates (PER) respectively reported by each of the plurality of client devices 104 in that zone, among plurality of zones 106A and 106B. In order to calculate the Target Error Recovery Rate (ERR_{Target}) value, the processor 206 first needs to calculate Packet Error Rate (PER) for each of the plurality of client devices 104 placed in that zone, among plurality of zones 106A and 106B using equation (2) given below:

$$PER = {N}_{missing} / {N}_{total} . \qquad ( 2 )$$

Wherein N_{missing} represents total number of missing packets reported by each of the plurality of client devices 104 in that zone, among plurality of zones 106A and 106B and Nₜₒₜₐₗ represents total number of packets received by each of the plurality of client devices 104 in that zone, among plurality of zones 106A and 106B.

Once the processor 206 has calculated Packet Error Rate (PER) for each of the plurality of client devices 104 in that zone, among plurality of zones 106A and 106B, the processor 206 is configured to calculate μ_{PER} that represents the mean of Packet Error Rate (PER) values and σ_{PER}that represents the standard deviation of the PER values. In an embodiment, to calculate σ_{PER} and μ_{PER} values, first outliers in the data packets shall be trimmed using techniques such as z-scores and then the mean and standard deviation values shall be calculated. Further, the processor 206 is configured to calculate the Target Error Recovery Rate (ERR_{Target}) value, from the calculated values of the μ_{PER} and the σ_{PER}, using equation (3) given below:

$$Target Error Recovery Rate ( {ERR}_{Target} ) value = {μ}_{PER} + 2 * {σ}_{PER} , \qquad ( 3 )$$

The processor 206 then optionally compares the calculated ERR_{Target} value with a predetermined maximum possible error recovery rate (ERR_{Max}) value stored in the memory 204. In an embodiment, the processor 206 may use the comparator module 210 to compare the calculated ERR_{Target} value with a predetermined maximum possible error recovery rate (ERR_{Max}) value. In response to the comparison, if the processor 206 determines that the ERR_{Target} value is less than equal to the ERR_{Max}, the processor 206 is configured to update FEC settings for each of the plurality of client devices 104 in that zone, among plurality of zones 106A and 106B by computing the number of parity symbols ‘p’ per coding block based on the number of source symbols ‘k’ per coding block.

Finally, after updating the FEC settings, the processor 206 requests the multicast servers 102 to update their FEC setting for each of the plurality of client devices 104, in that zone, among plurality of zones 106A and 106B, based on the calculated ERR_{FEC value}.

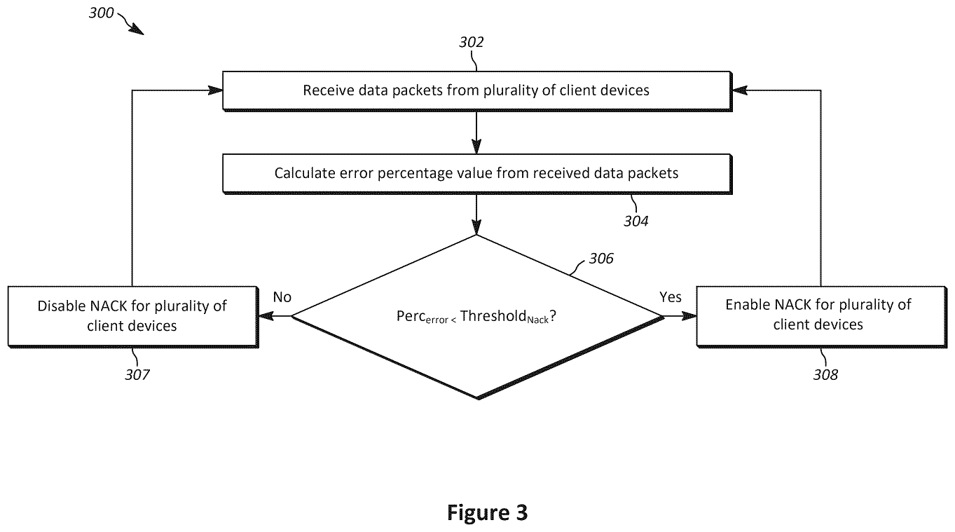

Referring now to FIG. 3, a flowchart illustrating a method for correcting errors occurring in a multicast session when using a Multicast Adaptive Bit rate (MABR) system for streaming content is disclosed.

As illustrated in FIG. 3, one disclosed embodiment comprises a method 300 that includes one or more flow steps for correcting errors occurring in a multicast session when using a Multicast Adaptive Bit rate (MABR) system for streaming content. The method 300 may include, at step 302, periodically receiving data packets from each of a plurality of client devices 104 (1A-nA) and 104 (1B-nB) placed across one or more zones 106A and 106B, respectively. In some embodiments, the data packets received from each of the plurality of client devices 104 (1A-Na) and 104 (1B-Nb) placed in each zone 106A and 106B, respectively, correspond to a single multicast session per zone. Further these data packets may include at least a total number of packets received, a number of packets with errors and/or a number of packets repaired in a multicast session. In a specific embodiment, the data packets received from each of the plurality of client devices 104 (1A-nA) and 104 (1B-nB) may include metrics indicating the existence of packet error. In an embodiment, the operations performed at step 302 may be performed by the transceiver 202 in combination with the processor 206 of the error correction unit 200 of FIG. 2.

At next step 304, the method 300 discloses calculating an error percentage (Percₑᵣᵣₒᵣ) value from the received data packets/metrices for each zone 106A and 106B independently. In an embodiment, the Percₑᵣᵣₒᵣ value is calculated by compiling the data packets received from each zone 106A and 106B separately. Further, the Percₑᵣᵣₒᵣ value is calculated continuously for the plurality of client devices 104(1A-nA) and 104 (1B-nB) placed in the zones 106A and 106B throughout the multicast session. In an embodiment, the operations performed at step 304 may be performed by the processor 206 of the error correction unit 200 of FIG. 2. Further, to calculate the Percₑᵣᵣₒᵣ value, the processor 206 may be configured to use equation (1) given below:

$$error percentage ( {Perc}_{error} ) value = ( {N}_{error} / {N}_{total} ) \times 100 , \qquad ( 1 )$$

wherein, Nₜₒₜₐₗ represents total number of client devices 104 present in a zone 106, among the plurality of zones 106A and 106B, when calculating error percentage (Percₑᵣᵣₒᵣ) value for that particular zone 106 and Nₑᵣᵣₒᵣ represents number of client devices 104 that experience uncorrected packet errors in that particular zone.

The method 300 at step 306 discloses comparing the calculated error percentage (Percₑᵣᵣₒᵣ) value with a pre-determined threshold NACK (Threshold_{Nack}) value. In an embodiment, the operations of step 306 may be performed by the comparator module 210 in combination with the processor 206, as shown in FIG. 2. Further, it is based on the output of the comparator module 210, the processor 206 takes the corrective action.

In an embodiment, if the comparator module 210 determines at step 306 whether or not the calculated error percentage (Percₑᵣᵣₒᵣ) value, for that particular zone, among the plurality of zones 106A and 106B is below a pre-determined threshold NACK (Threshold_{Nack}) value. If the answer is yes, at step 308 the method 300 selectively enables (or continues) a Not-Acknowledge (NACK) setting for each of the plurality of client devices 104 in that zone, among the plurality of zones 106A and 106B. In an exemplary aspect, the operations of step 308 may be performed by the processor 206 in combination with a NACK enablement module 208 as shown in FIG. 2.

Conversely, if the comparator module 210 determines, at step 306, that the calculated error percentage (Percₑᵣᵣₒᵣ) value, in that particular zone, is above or equal to the pre-determined threshold NACK (Threshold_{Nack}) value, the method 300 moves to step 307. At step 307 the method 300 disables (or does not enable) the NACK setting for each of the plurality of client devices 104 placed in that particular zone, among the plurality of zones 106A and 106B.

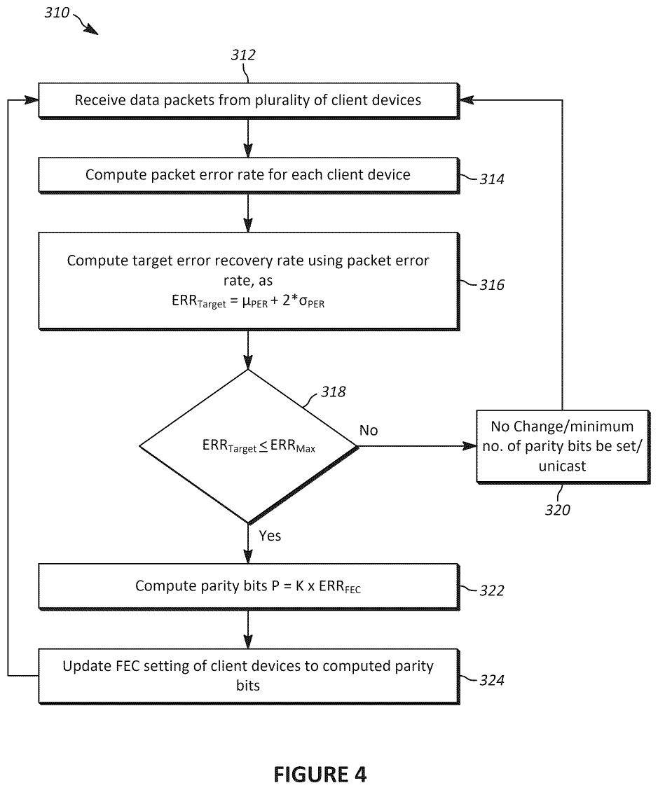

As noted above, in some embodiments, when the NACK setting is disabled in step 307, the method 300 may enable an FEC setting, and conversely when the NACK setting is enabled the method 300 may disable an FEC setting. In other words, in such embodiments the method 300 may enable a selective one of either a NACK setting or an FEC setting, depending upon the number of clients reporting packet errors. In other embodiments, the method 300 may be performed while simultaneously performing FEC error correction. Although some such embodiments as described above may utilize static FEC error correction where the number of parity bits remains constant, in a preferred embodiments, regardless of whether FEC error correction is performed instead of using the disclosed NACK setting or in addition to using the disclosed NACK setting, the FEC error correction is dynamic, where the number of parity bits used in a zone is adjusted based on contemporaneous error measurements received from the plurality of client devices 104 in that zone. FIG. 4 shows such a method that performs dynamic FEC error correction.

As noted above, the purpose of dynamic FEC error correction is to adjust the number of parity bits used for FEC correction based on the number of client devices experiencing packet errors (missing packets). During high-quality network conditions in a zone, for example, most client devices may receive all packets, and therefore transmitting many parity bits may waste bandwidth and/or computational resources, but if network conditions in a zone degrade, more parity bits may be required. Thus, dynamic adjustment of the number of parity bits sent to client devices in any particular zone has the benefit of more efficient usage of bandwidth and other network resources. As explained in more detail below, the disclosed dynamic error correction methods preferably collect statistics from the client devices that enable the computation of a statistically-expected target error recovery rate, i.e. a target packet error rate that will enable a desired percentage of client devices to correct all errors. In some preferred embodiments, this desired percentage of client devices is 95%, which can be easily computed from collected data on the assumption that packet error rates experienced by client devices in a zone obey a normal (Gaussian) distribution. Once this target packet error rate is computed, the number of parity bits needed to attain that target packet error rate may be calculated, and the FEC settings of the client devices 104 and the error correction unit 110 may be updated accordingly. The method 300 may then revert to step 302.

Specifically, FIG. 4 shows a method 310 that includes an initial step 312 of receiving data packets from the plurality of client devices, the data backets containing information regarding packet error rates experienced by each of the client devices. For example, the received data packets may be heartbeat messages as described above, and may include for each client device 104 a first value Nmissing, which represents the total number of missing packets reported by an individual client device, and a second value Ntotal, which represents the total number of packets received by that client device. Those of ordinary skill in the art will appreciate that step 312 of method 310 may correlate with step 302 of method 300 i.e., a single data collection step may receive information needed for implementing both the NACK setting procedure and the dynamic FEC error correction procedures disclosed herein.

At step 314, the processor 206 first preferably calculates a Packet Error Rate (PER) for each of the plurality of client devices 104 placed in that particular zone, among the plurality of zones 106A and 106B using the equation (2) given below:

$$PER = {N}_{missing} / {N}_{total} . \qquad ( 2 )$$

Wherein N_{missing} represents total number of missing packets reported by each of the plurality of client devices 104 placed in that particular zone, among the plurality of zones 106A and 106B and Nₜₒₜₐₗ represents total number of packets received by each of the plurality of client devices 104 placed in that particular zone, among the plurality of zones 106A and 106B.

At step 316, a target error recovery rate may be computed by the processor 206 using the individual PER samples from the client devices. Specifically, assuming the collected PER samples are normally distributed, a target error recovery rate computed to achieve a desired percentage of client devices 104 that are able to correct all errors may be determined using the mean and standard deviation of the collected PER samples. For example, if it is desired that 95% of all client devices be able to correct all errors based on the collected statistics, a target error recovery rate that achieves that percentage would be twice the standard deviation about the mean of the collected PER samples. Therefore, in a preferred embodiment, the method 310 calculating a μ_{PER} value, which represents the mean of Packet Error Rate (PER) values as well as a σ_{PER} value, which represents the standard deviation of the PER values. In an embodiment, to calculate the σ_{PER} and μ_{PER} values, outliers in the data packets may be trimmed using techniques such as z-scores, and then the mean and standard deviation values may be calculated. In a preferred embodiment, step 316 calculates the target error recovery rate according to the equation (3) given below:

$$Target Error Recovery Rate ( {ERR}_{Target} ) value = {μ}_{PER} + 2 * {σ}_{PER} , \qquad ( 3 )$$

The method 310 may optionally include a step 318 that compares the calculated ERR_{Target} to a threshold maximum error recovery rate ERR_{Max}. The purpose of this optional step is to enforce a maximum number of allowed parity bits; if so many parity bits are required to achieve the desired percentage of client devices that are able to fully correct for missing packets, network conditions would have necessarily degraded to the point that it could be expected that client devices resort to unicast rather than multicast. Thus, in embodiments where step 318 is utilized, if it is determined that ERR_{Target} is greater than ERR_{Max}, then some appropriate default action may be taken at step 320, such as no adjustment to parity bits be made and/or a minimum number of parity bits be set for the client devices in a zone, etc.

Conversely, if at step 318 ERR_{Target} is less than or equal to ERR_{Max} (or if step 318 is not used in method 310) a Forward Error Correction's (FEC) error recovery rate (ERR_{FEC}) for each of the plurality of client devices 104 placed in the respective zone of those client devices is set to the computed target error recovery rate ERR_{Target}. ERR_{FEC} is represented by p/k, wherein “p” represents number of parity symbols per coding block and “k” represents number of source symbols per coding block within a data packet of the streamed multimedia session coded using FEC technique. Thus, at step 322, the number of parity bits required to achieve the desired ERR_{Target} may be calculated as ERR_{FEC}* k. At step 324 the FEC settings of the client devices in 104 in a zone may be updated, and the error correction unit 110 also updated to use that number of parity bits for such client devices. The method 310 may then revert to step 312.

Those of ordinary skill in the art will appreciate that the operations of each of the methods 300 and 310 may preferably be performed by the processor 206 in combination with the FEC correction module 212, as shown in FIG. 2.

The foregoing methods may be described in the general context of computer executable instructions. Generally, computer executable instructions can include routines, programs, objects, components, data structures, procedures, modules, and functions, which perform specific functions or implement specific abstract data types. In one aspect, the methods may be performed by an apparatus comprising the processor 206 and the memory 204 of the error correction unit 110.

The order in which the various operations of the methods are described is not intended to be construed as a limitation, and any number of the described method flow steps can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

The various operations of methods described above may be performed by any suitable means capable of performing the corresponding functions. The means may include various hardware and/or software component(s) and/or module(s), including, but not limited to the processor 206 of FIG. 2 and the various units of FIG. 2. Few operations of the methods may be implemented at an external server as well. Generally, where there are operations illustrated in Figures, those operations may have corresponding counterpart means-plus-function components.

In a non-limiting embodiment of the present disclosure, one or more non-transitory computer-readable media may be utilized for implementing the embodiments consistent with the present disclosure. A computer-readable media refers to any type of physical memory (such as the memory 204) on which information or data readable by a processor may be stored. Thus, a computer-readable media may store one or more instructions for execution by the processor 206, including instructions for causing the processor 206 to perform steps or stages consistent with the embodiments described herein. The term “computer-readable media” should be understood to include tangible items and exclude carrier waves and transient signals. By way of example, and not limitation, such computer-readable media can comprise Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Thus, certain aspects may comprise a computer program product for performing the operations presented herein. For example, such a computer program product may comprise a non-transitory computer readable media having instructions stored (and/or encoded) thereon, the instructions being executable by one or more processors to perform the operations described herein. For certain aspects, the computer program product may include packaging material.

The various illustrative logical blocks, modules, and operations described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may include a microprocessor, but in the alternative, the processor may include any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise.

The terms “an embodiment”, “embodiment”, “embodiments”, “the embodiment”, “the embodiments”, “one or more embodiments”, “some embodiments”, and “one embodiment”, “other embodiment”, “yet another embodiment”, “non-limiting embodiment” mean “one or more (but not all) embodiments of the disclosure(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

A description of an embodiment with several components in communication with each other does not imply that all such components are required. On the contrary, a variety of optional components are described to illustrate the wide variety of possible embodiments of the disclosed methods and systems.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the appended claims.

### REFERRAL NUMERALS

| Reference Number | Description |
|---|---|
| 100 | BASIC ARCTICTUTRE OF MABR SYSTEM FOR |
| | CORRECTING ERRORS OCCURING IN |
| | MULTICAST SESSION |
| 102A | MULTICAST SERVER A |
| 102B | MULTICAST SERVER B |
| 106A | ZONE A |
| 106B | ZONE B |
| 104-1A-104-nA | CLIENT DEVICES IN ZONE A |
| 104-1B-104-nB | CLIENT DEVICES IN ZONE B |
| 108 | NETWORK |
| 112, 200 | ERROR CORRECTION UNIT |
| 202 | TRANCEIVER |
| 204 | MEMORY |
| 206 | PROCESSOR |
| 208 | NACK ENABLEMENT MODULE |
| 210 | COMPARATOR MODULE |
| 212 | FEC CORRECTION MODULE |
| 300 and 310 | METHOD FLOW CHARTS |
| 302-308, 312-324 | METHOD STEPS |

We claim:

1. A Multicast Adaptive Bitrate (MABR) system for correcting errors occurring in a multicast session, the system comprising:
a processor configured to:
periodically receive data packets from each of a plurality of client devices, the data packets received from each of the plurality of client devices including metrics indicating the existence of packet error;
selectively disable a Not-Acknowledge (NACK) setting for each of the plurality of client devices using a first set of the metrics; and
dynamically adjust a Forward Error Correction (FEC) setting for each of the plurality of client devices using a second set of the metrics different than the first set of the metrics, where dynamic adjustment of the FEC setting changes the first set of metrics in a manner that affects the selective disabling of the NACK setting for each of the plurality of client devices.

2. The system of claim 1, wherein the processor uses the first set of the metrics, received from each of the plurality of client devices, to calculate an error percentage value (Percₑᵣᵣₒᵣ) used to selectively disable the NACK setting for each of the plurality of client devices.

3. The system of claim 2, wherein the processor is configured to selectively enable the NACK setting for each of the plurality of client devices based on the first set of the metrics.

4. The system of claim 3, wherein to dynamically adjust the FEC error setting for each of the plurality of client devices, the processor is configured to calculate a target error recovery rate for each of the plurality of client devices, using the second set of the metrics.

5. The system of claim 4, wherein the target error recovery rate is represented by p/k, wherein “p” is number of parity symbols per coding block and “k” is the number of source symbols per coding block within a data packet of the multicast session.

6. A method for correcting errors occurring in a multicast session, the method comprising:
periodically receiving data packets from each of a plurality of client devices, the data packets received from each of the plurality of client devices including metrics including the existence of packet error;
selectively disabling a Not-Acknowledge (NACK) setting for each of the plurality of client devices using a first set of the metrics; and
dynamically adjusting a Forward Error Correction (FEC) setting for each of the plurality of client devices using a second set of the metrics different from the first set of the metrics, where dynamic adjustment of the FEC setting changes the first set of metrics in a manner that affects the selective disabling of the NACK setting for each of the plurality of client devices.

7. The method of claim 6, wherein the first set of the metrics are used to calculate an error percentage value used to selectively disable the NACK setting for each of the plurality of client devices.

8. The method of claim 6, further comprising selectively enabling the NACK setting for each of the plurality of client devices based on the first set of the metrics.

9. The method of claim 8, wherein for dynamically adjusting the FEC error setting for each of the plurality of client devices, the method comprises calculating a target error recovery rate (ERR_{FEC}) using the second set of the metrics.

10. The method of claim 9, wherein the target error recovery rate is represented by p/k, wherein “p” represents number of parity symbols per coding block and “k” represents number of source symbols per coding block within a data packet of the multicast session.

11. A processing device delivering an adaptive bitrate multicast to a plurality of client devices grouped in a zone, the multicast comprising a plurality of packets and the processing device receiving messages from each of the plurality of client devices quantifying a number of packet errors received in the multicast, the processing device configured to dynamically adjust a number of FEC parity bits sent in the multicast based on the quantified number of packet errors.

12. The processing device of claim 11 configured to adjust the number of parity bits sent in the multicast based on at least one statistical metric that quantifies a target error rate by which a specified percentage of the plurality of client devices are able to correct all packet errors using the parity bits.

13. The processing device of claim 12 where the at least one statistical metric includes a mean and a standard deviation of a population comprising the quantified number of packet errors received from each of the plurality of client devices.

14. The processing device of claim 11 configured to toggle the client devices in the zone between a first state enabling a NACK setting and a second state disabling a NACK setting.

15. The processing device of claim 14 where the dynamic adjustment of the number of FEC parity bits modulates the toggling of the client devices between the first state and the second state.
